(19) United States
(12) Patent Application Publication
(10) Pub. No.: US 2026/0366100 A1
(43) Pub. Date: Nov. 19, 2026

(54) METHOD FOR PURIFYING LEACH SOLUTIONS

(71) Applicant: BASF SE, Ludwigshafen am Rhein (DE)

(72) Inventors: Maximilian RANG, Ludwigshafen (DE); Wolfram WILK, Ludwigshafen (DE); Marc DUCHARDT, Ludwigshafen (DE); Anne-Marie Caroline ZIESCHANG, Mannheim (DE); Fabian SEELER, Ludwigshafen (DE); Wolfgang ROHDE, Ludwigshafen (DE); Kerstin SCHIERLE-ARNDT, Ludwigshafen (DE); Vincent SMITH, Johannesburg (ZA)

(21) Appl. No.: 19/158,723

(22) PCT Filed: Mar. 6, 2024
(86) PCT No.: PCT/EP24/55903

§ 371 Date: Aug. 21, 2025

(30) Foreign Application Priority Data
Mar. 10, 2023 (EP) 23161288.8

(51) Int. Cl. C22B 3/44; C22B 7/00; H01M 10/54

(52) U.S. Cl. CPC C22B 3/44; C22B 7/007; H01M 10/54

(57) ABSTRACT

Disclosed herein is a method for purifying a leach solution of a material, the material including one or more metals in a zero oxidation state and one or more chosen from metal oxides, metal hydroxides, metal carbonates and combinations thereof, where the method includes providing a leach mixture, after stirring the leach mixture for a first time span during a total time span, treating the leach mixture with activated carbon, after which the stirring is continued for a second time span during the total time span to obtain a leach mixture enriched with activated carbon, and subjecting the leach mixture enriched with activated carbon to a separation process to obtain a residue and as a supernatant a purified leach solution in the form of an aqueous solution including metal ions.

### FIELD OF THE INVENTION

The present disclosure relates to processes for purifying a leach solution of a material such as, for example, a battery material, processes for separating various metals and metal compounds from a material such as, for example, a battery material, and processes for recycling lithium ion battery materials.

### BACKGROUND

High purity lithium is a valuable resource. Many sources of lithium, such as lithium ion batteries, lithium ion battery waste, lithium containing water, e.g. ground water, and raw lithium containing ores, are complex mixtures of various elements and compounds. The removal and purification of lithium from a material, such as a lithium ion battery material, are exemplary steps in the recycling of lithium ion batteries. Lithium ion battery materials are complex mixtures of various elements and compounds, and it may be desirable to remove various non-lithium impurities. Such impurities may exist in a variety of oxidation states which may impact, for example, the efficiency of a leaching process. For example, in some leaching processes high oxidation state metals may be more or less efficiently leached than low or zero oxidation state metals. Some non-lithium impurities are also valuable resources, and it may additionally be desirable to separate and purify various elements and compounds from such materials.

Accordingly, there is a need for leaching methods for efficiently and effectively leaching complex mixtures of various elements and compounds such as, for example, mixed metals coexisting in a variety of oxidation states. For example, there is a need for economic processes with high lithium recovery and high lithium purity. There is also a need for economic processes with high recovery and high purity for removing value metals such as, for example, nickel and cobalt, from materials.

WO 2021/174348 A1 discloses a method for processing a black mass material from lithium iron phosphate batteries comprising a) receiving a black mass material feed material; b) acid leaching the black mass material at a pH that is less than 4, thereby producing a pregnant leach solution (PLS) comprising at least 80% of the lithium from the black mass feed material, and at least a portion of the iron and the phosphorous from the black mass feed material; providing a first intermediary solution after completing step b); and separating at least 90% of the iron and the phosphorous from the first intermediary solution to provide an output solution.

However, in some leaching processes undesired emulsification may occur which may impact, for example, the efficiency of separation processes following the respective leaching processes. Accordingly, there is a need for processes for removing, at least partially, undesired emulsifiers and/or dispersion reagents from a respective leach solution of a material, thus, rendering the respective subsequent separation processes still more efficient and effective.

### SUMMARY OF THE INVENTION

Disclosed herein are methods for providing a purified leach solution of a material, the material comprising one or more metals in a zero oxidation state and one or more chosen from metal oxides, metal hydroxides, metal carbonates and combinations thereof. Each such method comprises contacting the material at a temperature ranging from 20 °C to 110 °C for a total time span ranging from 20 minutes to 10 hours with an acidic aqueous solution having a pH less than 6 and comprising one or more acids chosen, for example, from HCl, H₂SO₄, CH₃SO₃H, HNO₃, whereby in the course of contacting a leach mixture of the material is formed, and after stirring the leach mixture for a first time span during the total time span, treating the leach mixture with activated carbon, whereafter the stirring is continued for a second time span during the total time span to obtain a leach mixture enriched with activated carbon, and subjecting the leach mixture enriched with activated carbon to a separation process, such as, for example, a filtering, to obtain a separation residue, such as, for example, a dry filter cake, and as a supernatant, such as, for example, a filtrate, a purified leach solution in the form of an aqueous solution comprising metal ions.

Also disclosed are methods comprising leaching a material by processing the material as described before to obtain an aqueous solution comprising metal ions, and separating the metal ions to obtain at least one essentially pure metal ion solution and/or at least one essentially pure solid metal ion salt. Further disclosed are methods comprising mechanically comminuting at least one material chosen from a lithium ion battery, lithium ion battery waste, lithium ion battery production scrap, lithium ion cell production scrap, lithium ion cathode active material, and combinations thereof to obtain a black mass, and leaching the black mass by processing the black mass as described before.

### DETAILED DESCRIPTION

Disclosed herein are methods for providing a purified leach solution of a material, the material comprising one or more metals in a zero oxidation state and one or more chosen from metal carbonates, metal oxides, metal hydroxides, and combinations thereof. Each such method comprises contacting the material at a temperature ranging from 20 °C to 110 °C for a total time span ranging from 20 minutes to 10 hours with an acidic aqueous solution having a pH less than 6 and comprising one or more acids chosen, for example, from HCl, H₂SO₄, CH₃SO₃H, HNO₃, whereby in the course of contacting a leach mixture of the material is formed, and, after stirring the leach mixture for a first time span during the total time span, treating the leach mixture with activated carbon, whereafter the stirring is continued for a second time span during the total time span to obtain a leach mixture enriched with activated carbon, and subjecting the leach mixture enriched with activated carbon to a separation process, such as, for example, a filtering, to obtain a separation residue, such as, for example, a dry filter cake, and as a supernatant, such as, for example, a filtrate, a purified leach solution in the form of an aqueous solution comprising metal ions.

In some embodiments, the acidic aqueous solution comprises at least one acid chosen from HCl, H₂SO₄, CH₃SO₃H, HNO₃, and combinations thereof. In some embodiments, the acidic aqueous solution further comprises one or more chosen from O₂, N₂O, and combinations thereof.

In some embodiments, the acidic aqueous solution comprises H₂SO₄. In some embodiments, the acidic aqueous solution comprises H₂SO₄ and O₂. In some embodiments, the acidic aqueous solution comprises O₂ and the O₂ is provided as air. In some embodiments, the acidic aqueous solution comprises sulfur dioxide, SO₂. In some embodiments the acidic aqueous solution comprises less than or equal to 3 volume % sulfur dioxide. In some embodiments, the acidic aqueous solution comprises air with less than or equal to 3 volume % sulfur dioxide.

In some embodiments, contacting the material with an acidic aqueous solution having a pH less than 6 causes a formation of hydrogen gas, and an oxidizing agent chosen from O₂ (e.g., air), N₂O, and combinations thereof is added after the formation of hydrogen gas.

In some embodiments, the one or more chosen from metal oxides or metal hydroxides comprising nickel, cobalt, or manganese contain these metals in an oxidation state of +2 in an amount ranging from 5 weight % to 10 weight %, 10 weight % to 20 weight %, or 20 weight % to 50 weight %, relative to the total weight of the one or more chosen from metal oxides or metal hydroxides comprising nickel, cobalt, or manganese.

The wordings “weight %” and “wt.-%” and “weight percent” and “weight ratio” are used synonymously herein.

In some embodiments, the acidic aqueous solution has a concentration of acid ranging from 18 mol/L to 0.0001 mol/L.

In some embodiments, contacting the material at a temperature ranging from 20 °C to 110 °C for the total time span ranging from 20 minutes to 10 hours with an acidic aqueous solution comprises:
suspending the material in deionized water to obtain a intermediary suspension,
subsequently treating the intermediary suspension, for example dropwise, with an amount of one or more of the acids chosen, for example, from HCl, H₂SO₄, CH₃SO₃H, HNO₃, and combinations thereof, to obtain a reaction mixture as the leach mixture.

In some embodiments, contacting the material at a temperature ranging from 20 °C to 110 °C for the total time span ranging from 20 minutes to 10 hours with an acidic aqueous solution further comprises
stirring the reaction mixture first under inert gas and then under aerobic conditions, and
adding to the reaction mixture one or more oxidants chosen from O₂, N₂O, and combinations thereof, to obtain the leach mixture.

In some embodiments, contacting the material at a temperature ranging from 20 °C to 110 °C for the total time span ranging from 20 minutes to 10 hours with an acidic aqueous solution further comprises
stirring the reaction mixture first under inert gas and then under aerobic conditions, and
adding one or more reductants and/or a base, to obtain the leach mixture.

In some embodiments, contacting the material at a temperature ranging from 20 °C to 110 °C for the total time span ranging from 20 minutes to 10 hours with an acidic aqueous solution further comprises
stirring the reaction mixture first under inert gas and then under aerobic conditions, and
adding to the reaction mixture one or more oxidants, and
adding one or more reductants and/or a base, to obtain the leach mixture.

In some embodiments, the activated carbon is chosen from activated carbon powder and granular activated carbon, e.g. with a 12×40 mesh. In principle, any form/structure of the activated carbon can be used, as long as it can be handled well in a respective process.

A quantity of activated carbon with which the material is treated is chosen to range from 0.1 weight percent to 10 weight percent, in some embodiments, the quantity of activated carbon with which the material is treated is chosen to range from 0.5 weight percent to 5 weight percent, in some embodiments, the quantity of activated carbon with which the material is treated is chosen to range from 1 weight percent to 2.5 weight percent, wherein each weight percent is by total weight of the material used.

In some embodiments, the quantity of activated carbon with which the material is treated is correlated with the second time span via a monotonically decreasing function, i.e. the smaller the quantity of activated carbon selected (within the quantity range from 0.1 weight percent to 10 weight percent as mentioned before), the longer the second time span to be selected, with otherwise identical experimental conditions and the same result obtained, i.e. a purified leach solution. As used herein, a purified leach solution is a leach solution essentially free from emulsifiers and/or dispersion reagents, which is shown, for example, by the fact that the time until a phase separation occurs after adding an organic solvent and shaking the resulting two-phase system, is less than 2 minutes.

The second time span to be selected ranges from 20 minutes to 6 hours. The first time span and the second time span add up to the total time span. In some embodiments, the first time span is 0 seconds, i.e. the leach mixture is treated with the activated carbon without being stirred before. In some embodiments, the activated carbon is added to the acidic aqueous solution at the same time as the material. In some embodiments, the activated carbon is added to the acidic aqueous solution subsequently to the material. The second time span may in this case correspond to the total time span.

In some embodiments, the separation process can be realised by filtering obtaining a filter cake and a filtrate as supernatant, by sedimenting obtaining a sediment and a supernatant or by centrifugalising obtaining a sediment and a supernatant.

In some embodiments, the material is a battery material, the battery material being a lithium ion battery material comprising one or more chosen from black mass, cathode active material, cathodes, cathode active material precursors, and combinations thereof, and/or wherein the battery material comprises one or more chosen from nickel, cobalt, manganese, and combinations thereof.

In some embodiments, the one or more metals in a zero oxidation state is chosen from lithium, nickel, cobalt, copper, aluminium, iron, manganese, rare earth metals, and combinations thereof. In some embodiments, the metal carbonates are chosen from lithium carbonates. In some embodiments, the metal oxides are chosen from nickel oxides, cobalt oxides, copper oxides, aluminium oxides, iron oxides, manganese oxides, rare earth oxides, and combinations thereof. In some embodiments, the metal hydroxides are chosen from lithium hydroxides, nickel hydroxides, cobalt hydroxides, copper hydroxides, aluminium hydroxides, iron hydroxides, manganese hydroxides, alkaline earth hydroxides, rare earth hydroxides, and combinations thereof.

In some embodiments, the material is chosen as a battery material that comprises:
from 0.1 weight percent to 10 weight percent lithium,
from 0 weight percent to 60 weight percent nickel,
from 0 weight percent to 20 weight percent cobalt,
from 0 weight percent to 20 weight percent copper,
from 0 weight percent to 20 weight percent aluminium,
from 0 weight percent to 20 weight percent iron, and
from 0 weight percent to 20 weight percent manganese;
   wherein each weight percent is by total weight of the battery material.

In some embodiments, a disclosed method comprises subjecting the at least one material to a heat treatment step. In some embodiments, the material such as for example a battery material or a precursor thereof is pyrolysed prior to contacting the material with the acidic aqueous solution.

In some embodiments, the acidic aqueous solution comprises O₂, the O₂ being provided as air, and the air being sparged through the acidic aqueous solution.

Also disclosed is a method comprising processing a material according to an embodiment of the previously described inventive method to obtain an aqueous solution comprising metal ions, and separating the metal ions to obtain at least one essentially pure metal ion solution and/or at least one essentially pure solid metal ion salt.

In some embodiments separating the metal ions comprises one or more of a solid/liquid separation, an extraction, a precipitation, a crystallization, and combinations thereof.

Further disclosed is a method comprising:
mechanically comminuting at least one material such as, for example, a battery material chosen from a lithium ion battery, lithium ion battery waste, lithium ion battery production scrap, lithium ion cell production scrap, lithium ion cathode active material, and combinations thereof to obtain a black mass, and
subjecting the black mass to a method according to an embodiment of the previously described inventive methods.

### DEFINITIONS

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, an “acidic aqueous solution” is an aqueous solution having a pH less than 7 capable of oxidizing a metal in a zero oxidation state. For example, some acidic aqueous solutions are capable of oxidizing some metals in a zero oxidation state but not others.

As used herein, an “oxidizing agent” is a compound capable of oxidizing a metal in a zero oxidation state. For example, some oxidizing agents are capable of oxidizing some metals in a zero oxidation state but not others.

As used herein, a “solution” is a combination of a fluid and one or more compounds. For example, each of the one or more compounds in the solution may or may not be dissolved in the fluid.

As used herein, a “leach mixture” is a reaction mixture that forms in the course of the contacting step.

As used herein, an “essentially pure metal ion solution” is a solution comprising a metal ion, a counter ion, a solvent; wherein the total weight of the metal ion and counter ion is at least 50% by weight excluding the weight of solvent.

As used herein, an “essentially pure solid metal ion salt” is a solid comprising a metal ion and a counter ion; wherein the total weight of the metal ion and counter ion is at least 50% by weight of the solid excluding the weight of solvent.

As used herein, the term “sparging” refers to dispersing a gas through a liquid.

As used herein, the term “base” refers to a material capable of reacting with a hydronium ion and to increase the pH-value of an acidic solution.

### Materials:

The material comprises one or more metals in a zero oxidation state and one or more chosen from metal oxides, metal hydroxides, and combinations thereof.

In some embodiments, the material comprises one or more chosen from lithium, nickel, cobalt, manganese, and combinations thereof.

In some embodiments, the one or more metals in a zero oxidation state is chosen from lithium, nickel, cobalt, copper, aluminum, iron, manganese, rare earth metals, and combinations thereof.

In some embodiments, the metal carbonates are chosen from lithium carbonates.

In some embodiments, the metal oxides are chosen from nickel oxides, cobalt oxides, copper oxides, aluminum oxides, iron oxides, manganese oxides, rare earth oxides, and combinations thereof.

In some embodiments, the metal hydroxides are chosen from lithium hydroxides, nickel hydroxides, cobalt hydroxides, copper hydroxides, aluminum hydroxides, iron hydroxides, manganese hydroxides, alkaline earth hydroxides, rare earth hydroxides, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material.

In some embodiments, the material, or a precursor thereof, is pyrolyzed prior to be processed by an embodiment of the inventive methods. In some embodiments, the pyrolysis is performed under an inert atmosphere, an oxidizing atmosphere, a reducing atmosphere, or a combination thereof.

In some embodiments, the material has a weight ratio ranging from 0.01 to 10, 0.01 to 5, 0.01 to 2, or 0.01 to 1 of lithium to a total weight of nickel, cobalt, manganese, copper, aluminum, iron, and phosphorus.

In some embodiments, the material is a lithium ion battery material comprising one or more chosen from black mass, cathode active material, cathodes, cathode active material precursors, and combinations thereof.

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material. In some embodiments, the black mass is subjected to a heat treatment.

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D₅₀) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

In some embodiments, mechanically treated battery scrap may be subjected to a heat treatment in a wide range of temperatures under different atmospheres. In some embodiments, the heat treatment is performed at a temperatures ranging from 350 °C to 900 °C. In some embodiments, the heat treatment is performed at a temperatures ranging from 450 °C to 800 °C. In some embodiments, the heat treatment is performed under an inert, oxidizing, or reducing atmosphere. In some embodiments, the heat treatment is performed under an inert or reducing atmosphere. In some embodiments, reducing agents are formed under the conditions of the heat treatment from pyrolyzed organic (polymeric) components. In some embodiments, reducing agents are formed by adding a reducing gas such as H₂ and/or CO.

In some embodiments, the material comprises at least one chosen from lithiated nickel cobalt manganese oxide, lithiated nickel cobalt aluminum oxide, lithium metal phosphate, lithium ion battery scrap, a black mass, and combinations thereof.

In some embodiments, the material comprises lithium metal phosphate of formula LiₓMPO₄, wherein x is an integer greater than or equal to one, and M is chosen from metals, transition metals, rare earth metals, and combinations thereof.

In some embodiments, the material comprises nickel, cobalt, manganese, copper, aluminum, iron, phosphorus, or combinations thereof.

In some embodiments, the material has a weight ratio ranging from 0.01 to 10 of lithium to a total weight of nickel, cobalt, manganese, copper, aluminum, iron, and phosphorus. In some embodiments, the material has a weight ratio ranging from 0.01 to 5 of lithium to a total weight of nickel, cobalt, manganese, copper, aluminum, iron, and phosphorus. In some embodiments, the material has a weight ratio ranging from 0.01 to 2 of lithium to a total weight of nickel, cobalt, manganese, copper, aluminum, iron, and phosphorus. In some embodiments, the material has a weight ratio ranging from 0.01 to 1 of lithium to a total weight of nickel, cobalt, manganese, copper, aluminum, iron, and phosphorus.

In some embodiments, the material comprises LiₓMO₂, wherein x is an integer greater than or equal to one, and M is chosen from metals, transition metals, rare earth metals, and combinations thereof.

### Leach Solution:

The method for purifying a leach solution of a material comprises: contacting the material with an acidic aqueous solution having a pH less than 6, the material comprises one or more metals in a zero oxidation state and one or more chosen from metal oxides, metal hydroxides, and combinations thereof. In the course of contacting a leach mixture of the material is formed.

The acidic aqueous solution comprises one or more acids chosen from HCl, H₂SO₄, CH₃SO₃H, HNO₃, and combinations thereof. In some embodiments, the acidic aqueous solution comprises at least one chosen from H₂SO₄, O₂, N₂O, and combinations thereof. In some embodiments, the acidic aqueous solution comprises H₂SO₄. The acidic aqueous solution further comprises one or more chosen from O₂, N₂O, and combinations thereof. In some embodiments, the acidic aqueous solution comprises an acid that is also an oxidizing agent such as, for example, H₂SO₄. In some embodiments, the acidic aqueous solution comprises an oxidizing agent that is not an acid such as, for example, O₂, N₂O, or combinations thereof. In some embodiments, the acidic aqueous solution comprises an acid and an oxidizing agent. In some embodiments, the acidic aqueous solution comprises an acid that is also an oxidizing agent and further comprises an oxidizing agent that is not an acid.

In some embodiments, the leach mixture is treated by reducing one or more chosen from metal oxides, metal hydroxides, and combinations thereof with a reducing agent. In some embodiments, the reducing agent is one or more chosen from SO₂, metabisulfite salts, bisulfite salts, thiosulfate salts, dithionate salts, H₂O₂, H₂, and combinations thereof.

In some embodiments, a black mass is slurred in water at a weight percentage of black mass by total weight of the slurry ranging from 5% to 30%. In some embodiments, the slurred black mass as the material is contacted with the acidic aqueous solution having a pH less than 6. In some embodiments, the acidic aqueous solution having a pH less than 6 is formed from the slurred black mass by addition of acid. In some embodiments, the weight ratio of H₂SO₄ in the acidic aqueous to black mass ranges from 1:1 to 2:1. In some embodiments, H₂SO₄ is added to adjust the pH during the contacting step.

In some embodiments, the black mass is provided as a slurry. In some embodiments, the black mass is provided as a slurry in water. In some embodiments, the black mass is provided as a slurry in aqueous side streams from subsequent treatment steps such as, for example, washing liquids from filters. In some embodiments, the black mass is provided as a solid.

Contacting the material with an acidic aqueous solution is performed at a temperature ranging from 20 °C to 110 °C. In some embodiments, contacting the material with an acidic aqueous solution is performed for a duration ranging from 20 minutes to 10 hours.

In some embodiments, the acidic aqueous solution comprises air. In some embodiments, the air comprises less than or equal to 3 volume % sulfur dioxide.

In some embodiments, contacting the material with an acidic aqueous solution having a pH less than 6 comprises sparging air through the acidic aqueous solution. In some embodiments, the air is sparged through the acidic aqueous solution at a rate of up to 20% solution volume/min. In some embodiments, the air is sparged through the acidic aqueous solution at a rate in the range of from 0.1% to 20% solution volume/min. The rate refers to the volume of O₂ being sparged through the acidic aqueous solution per minute, i.e., it is equal to approximately 21% of the volume of air being sparged through the solution.

In some embodiments, the acidic aqueous solution has a pH ranging from −1.0 to 3.

In some embodiments, contacting the material with an acidic aqueous solution having a pH less than 6 comprises first contacting the material with an acid and, subsequently, adding an oxidizing agent chosen from O₂, N₂O, and combinations. In some embodiments, contacting the material with an acidic aqueous solution having a pH less than 6 comprises first contacting the material with an acid causing a formation of hydrogen gas and, subsequent to the formation of hydrogen gas (i.e., after the formation of hydrogen gas has subsided), adding an oxidizing agent chosen from O₂, N₂O, and combinations. In some embodiments, contacting the material with an acidic aqueous solution having a pH less than 6 comprises first contacting the material with an acid causing a formation of hydrogen gas, monitoring the formation of hydrogen gas by gas chromatography and/or hydrogen sensors, and, subsequent to the formation of hydrogen gas (i.e., after the formation of hydrogen gas has subsided), adding an oxidizing agent chosen from O₂, N₂O, and combinations. In some embodiments, contacting the material with an acidic aqueous solution having a pH less than 6 comprises first contacting the material with an acid causing a formation of hydrogen gas, monitoring the formation of hydrogen gas by gas chromatography and/or hydrogen sensors, and, when the concentration of hydrogen gas is less than 5 volume %, for example less than 1 volume % for example less than 0.1 volume %, adding an oxidizing agent chosen from O₂, N₂O, and combinations.

In some embodiments, excess oxidizing gas O₂, such as in air, and/or N₂O is recycled from the off-gas back into the leaching reactor.

In some embodiments, the optional reducing agent comprises SO₂ and the SO₂ is sparged through the solution at a rate of up to 20% solution volume/min. In some embodiments, the SO₂ is sparged through the solution at a rate in the range of from 0.1% to 20% solution volume/min. In some embodiments, the SO₂ is sparged through the solution for 1 hour to 3 hours.

In some embodiments, the optional reducing step is performed at ambient temperature.

In some embodiments, the method is performed batchwise.

In some embodiments, contacting the material with an acidic aqueous solution is carried out at ambient pressure. In some embodiments, contacting the material with an acidic aqueous solution is carried out at an elevated pressure.

In some embodiments, the contacting step is at a temperature ranging from 20 °C to 110 °C for a total time span ranging from 20 minutes to 10 hours. The second time span within the total time span ranges from 20 minutes to 6 hours. In some embodiments, the second time span within the total time span ranges from 1 hour to 5 hours. In some embodiments, the second time span within the total time span ranges from 2 hours to 4 hours. The second time span is highly correlated with the quantity of activated carbon with which the material is treated. The quantity of activated carbon is chosen to range from 0.1 weight percent to 10 weight percent, in some embodiments, the quantity of activated carbon with which the material is treated is chosen to range from 0.5 weight percent to 5 weight percent, in some embodiments, the quantity of activated carbon with which the material is treated is chosen to range from 1 weight percent to 2.5 weight percent, wherein each weight percent is by total weight of the material that is carbon with which the material is treated is correlated with the second time treated with the activated carbon.

In some embodiment, the quantity of activated span via a monotonically decreasing function, i.e., the smaller the quantity of activated carbon selected within the above described quantity range, the longer the second time span to be selected in order to obtain after the separation step a purified leach solution in the form of an aqueous solution comprising metal ions.

The advantage of the purification method presented herein is that emulsifying agents and/or dispersion reagents present in the provided leach mixture are adsorbed, at least in part, by the added activated carbon, and these emulsifying agents and/or dispersion reagents can be extracted or separated, e.g. filtered out from the leach mixture together with the activated carbon in the separating step, leaving a purified leach solution. The purified leach solution can be subjected to further specific separation steps in order to separate targeted specific metal ions.

Such emulsifying agents and/or dispersion reagents present in the leach mixture may be from the group comprising Si, C, O, nanoparticles with a particle size <500 nm, gel-like SiOx networks, polysiloxane and derivates, organic residues from a previous pyrolysis of organic binders, and combinations thereof. In some cases, Si-containing surfactants are generated when a respective binder is not pyrolyzed sufficiently during a prior heat treatment of the material such as, for example, a black mass.

Nanoparticles with a particle size <500 nm may be e.g. SiO₂, Cu, intact CAM (cathode active material). Organic binders that are typically used in batteries are, e.g., PVDF (polyvinylidene fluoride), SBR (styrene-butadiene) and any combination thereof. Gel-like SiOx networks, polysiloxane and organic residues act themselves as emulsifying agents or as dispersion reagents which hold particles in suspension/dispersion.

In some embodiments, the method comprises purifying a leach solution of a material as disclosed herein to obtain an aqueous solution comprising metal ions and separating the metal ions to obtain at least one essentially pure metal ion solution and/or at least one essentially pure solid metal ion salt.

In some embodiments, an essentially pure solid metal ion salt is a solid comprising a metal ion and a counter ion; wherein the total weight of the metal ion and counter ion is at least 50% by weight of the solid excluding the weight of solvent such as all water. In some embodiments, an essentially pure solid metal ion salt is a solid comprising a metal ion and a counter ion; wherein the total weight of the metal ion and counter ion is at least 70% by weight of the solid excluding the weight of solvent. In some embodiments, an essentially pure solid metal ion salt is a solid comprising a metal ion and a counter ion; wherein the total weight of the metal ion and counter ion is at least 80% by weight of the solid excluding the weight of solvent. In some embodiments, an essentially pure solid metal ion salt is a solid comprising a metal ion and a counter ion; wherein the total weight of the metal ion and counter ion is at least 90% by weight of the solid excluding the weight of solvent. In some embodiments, an essentially pure solid metal ion salt is a solid comprising a metal ion and a counter ion; wherein the total weight of the metal ion and counter ion is at least 95% by weight of the solid excluding the weight of solvent. In some embodiments, an essentially pure solid metal ion salt is a solid comprising a metal ion and a counter ion; wherein the total weight of the metal ion and counter ion is at least 99% by weight of the solid excluding the weight of solvent.

In some embodiments, an essentially pure metal ion solution is a solution comprising a metal ion, a counter ion, and a solvent; wherein the total weight of the metal ion and counter ion is at least 50% by weight of the solution excluding the weight of solvent. In some embodiments, an essentially pure metal ion solution is a solution comprising a metal ion, a counter ion, a solvent; wherein the total weight of the metal ion and counter ion is at least 70% by weight of the solution excluding the weight of solvent. In some embodiments, an essentially pure metal ion solution is a solution comprising a metal ion, a counter ion, a solvent; wherein the total weight of the metal ion and counter ion is at least 80% by weight of the solution excluding the weight of solvent. In some embodiments, an essentially pure metal ion solution is a solution comprising a metal ion, a counter ion, a solvent; wherein the total weight of the metal ion and counter ion is at least 90% by weight of the solution excluding the weight of solvent. In some embodiments, an essentially pure metal ion solution is a solution comprising a metal ion, a counter ion, a solvent; wherein the total weight of the metal ion and counter ion is at least 95% by weight of the solution excluding the weight of solvent. In some embodiments, an essentially pure metal ion solution is a solution comprising a metal ion, a counter ion, a solvent; wherein the total weight of the metal ion and counter ion is at least 99% by weight of the solution excluding the weight of solvent.

In some embodiments, separating the metal ions to obtain at least one essentially pure metal ion solution and/or at least one essentially pure solid metal ion salt comprises one or more of a solid/liquid separation, an extraction, a precipitation, a crystallization, and combinations thereof.

In some embodiments, the method can be performed in part or in whole as a continuous process controlled by sensors and actuators as part of a computer based process control system.

### Oxidizing Agents:

In some embodiments, the acidic aqueous solution comprises an oxidizing agent. In some embodiments, an oxidizing agent is an acid such as, for example, H₂SO₄, HNO₃, and combinations thereof. In some embodiments, an oxidizing agent is not an acid such as, for example, O₂, N₂O, and combinations thereof.

In some embodiments, the acidic aqueous solution comprises an acid that is not an oxidizing agent and an oxidizing agent that is not an acid. In some embodiments, the acidic aqueous solution comprises an acid that is an oxidizing agent and an oxidizing agent that is not an acid. In some embodiments, the acidic aqueous solution comprises an acid that is not an oxidizing agent and an oxidizing agent that is an acid. In some embodiments, the acidic aqueous solution comprises an acid that is an oxidizing agent and an oxidizing agent that is an acid. In some embodiments, the acidic aqueous solution comprises an acid that is an oxidizing agent. In some embodiments, an acidic aqueous solution is an oxidizing acidic aqueous solution. In some embodiments, the acidic aqueous solution is not an oxidizing acidic aqueous solution.

### EXAMPLES

The following examples are intended to be illustrative and are not meant in any way to limit the scope of the disclosure.

### ABBREVIATIONS

% percent
wt.-% weight percent
ppm parts per million
Li lithium
Ni nickel
Co cobalt
Mn manganese
Cu copper
Al aluminium
Fe iron
P phosphorus
F fluorine
Ca calcium
C carbon
Si silicium
Ti titanium
K potassium
Mg magnesium
Na sodium
Zn zinc

### Black Mass

For the Examples provided below, a black mass was obtained by mechanical comminution of lithium ion batteries and subsequent separation of the black mass as a fine powder from the other constituents of the lithium ion batteries. The black mass was obtained by a process involving a pyrolysis of battery scrap. The material may contain low amounts of sulfur. The metals analyzed are present as oxidic compounds like MnO, CoO, NiO, as salts like LiF, LiO, LiOH, LiAlO₂, Li₂CO₃, and/or as zero oxidation state metals like nickel, cobalt, and copper. The carbon is elemental carbon mainly in the form of graphite with some soot or coke.

The respective composition of the black mass used in the following Examples is provided in the following tables.

TABLE 1
Composition of Black Mass used in Examples 1, 2, 3, 4, 7 and
8 where only contained elements with a quantity equal or greater
than 0.01 wt.-% are named in the table. Each weight precent
(wt.-%) refers to the total weight of the black mass used.

| Element | Weight Percent | |
|---|---|---|
| Al | 6.6 | wt.-% |
| Ca | 1.03 | wt.-% |
| Co | 7.5 | wt.-% |
| Cu | 4.2 | wt.-% |
| C | 34.5 | wt.-% |
| Fe | 0.61 | wt.-% |
| K | 0.017 | wt.-% |
| Li | 3.5 | wt.-% |
| Mg | 0.08 | wt.-% |
| Mn | 4.5 | wt.-% |
| Na | 0.04 | wt.-% |
| Ni | 14.5 | wt.-% |
| P | 0.67 | wt.-% |
| Si | 0.38 | wt.-% |
| Ti | 0.037 | wt.-% |
| Zn | 0.01 | wt.-% |
| F | 4.0 | wt.-% |

TABLE 2
Composition of Black Mass used in Example 5 where only
contained elements with a quantity greater than 0.01
wt.-% are named in the table.. Each weight precent (wt.-%)
refers to the total weight of the black mass used.

| Element | Weight Percent | |
|---|---|---|
| Al | 5.8 | wt.-% |
| Ca | 0.33 | wt.-% |
| Co | 10.3 | wt.-% |
| Cu | 7.5 | wt.-% |
| C | 28.7 | wt.-% |
| Fe | 0.46 | wt.-% |
| K | 0.022 | wt.-% |
| Li | 3.8 | wt.-% |
| Mg | 0.1 | wt.-% |
| Mn | 7.2 | wt.-% |
| Na | 0.058 | wt.-% |
| Ni | 10.0 | wt.-% |
| P | 0.59 | wt.-% |
| Si | 0.87 | wt.-% |
| Ti | 0.031 | wt.-% |
| Zn | 0.08 | wt.-% |
| F | 3.5 | wt.-% |

TABLE 3
Composition of Black Mass used in Example 6 where only
contained elements with a quantity greater than 0.01
wt.-% are named in the table.. Each weight precent (wt.-%)
refers to the total weight of the black mass used.

| Element | Weight Percent | |
|---|---|---|
| Al | 2.7 | wt.-% |
| Ca | 0.06 | wt.-% |
| Co | 4.1 | wt.-% |
| Cu | 1.8 | wt.-% |
| C | 54 | wt.-% |
| Fe | 0.03 | wt.-% |
| K | 0.01 | wt.-% |
| Li | 2.8 | wt.-% |
| Mg | 0.04 | wt.-% |
| Mn | 3.9 | wt.-% |
| Na | 0.01 | wt.-% |
| Ni | 12.4 | wt.-% |
| P | 0.58 | wt.-% |
| Si | 0.3 | wt.-% |
| Ti | 0.02 | wt.-% |
| Zn | 0.01 | wt.-% |
| F | 2.4 | wt.-% |

### Example 1

### Leaching

In this example, 50 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 5.5 h. Additionally, during leaching under aerobic conditions an oxidant was added into the reaction mixture. The resulting leach mixture was stirred. After stirring for a first time span of 5 h the leach mixture was treated with 2.5 g of analytical grade activated carbon powder, whereafter the heating was turned off and it was stirred for a second time span of 30 min. A leach mixture enriched with activated carbon was obtained. The leach mixture enriched with activated carbon was left to cool down to 60 °C and was then filtered off through a filter chute. This way a purified leach solution as filtrate and a dry filter cake could be obtained.

### Phase Separation

After letting the filtrate stand overnight, 10 ml of kerosene were placed into a reaction vessel which was subsequently treated with 20 ml of the filtrate. The resulting two-phase system was shaken vigorously for 1 min, whereafter the phase separation occurred within 60 s. This same procedure was repeated 5 days later, were the phase separation again occurred within 60 s.

The time until the occurrence of the phase separation is called waiting time in the following.

### Example 2 (Comparative)

### Leaching

In this example, 50 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 6 h.

Additionally, during leaching under aerobic conditions an oxidant was added into the reaction mixture. The suspension was left to cool down to 60 °C and was then filtered off through a filter chute. This way a filtrate and a dry filter cake could be obtained. A total organic carbon (TOC) content of 0,017 weight % was determined wherein each weight percent is by total weight of the filtrate.

Phase Separation After letting the filtrate stand overnight, 10 mL of kerosene were placed into a reaction vessel which was subsequently treated with 20 mL of the filtrate. The resulting two-phase system was shaken vigorously for 1 min. Phase separation did not occur.

### Example 3

### Leaching

In this example, 50 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 5 h. Additionally, during leaching under aerobic conditions an oxidant was added into the reaction mixture. The resulting leach mixture was stirred. After stirring for a first time span of 2 h the leach mixture was treated with 0.1 g of granular activated carbon with a 12×20 mesh, whereafter the stirring was continued for a second time span of 3 h. A leach mixture enriched with activated carbon was obtained. The leach mixture enriched with activated carbon was left to cool down to 60 °C and was then filtered off through a filter chute. This way a filtrate and a dry filter cake could be obtained. A total organic carbon (TOC) content of 0,013 weight % was determined wherein each weight percent is by total weight of the filtrate.

### Phase Separation

After letting the filtrate stand overnight, 10 mL of kerosene were placed into a reaction vessel which was subsequently treated with 20 ml of the filtrate. The resulting two-phase system was shaken vigorously for 1 min, whereafter almost complete phase separation occurred after 90 s.

### Example 4

### Leaching

In this example, 75 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 6 h. Additionally, during leaching under aerobic conditions an oxidant was added into the reaction mixture. The resulting leach mixture was stirred. After stirring for a first time span of 3 h the leach mixture was treated with 0.38 g of granular activated carbon with a 12×40 mesh to obtain a leach mixture enriched with activated carbon, whereafter the stirring was continued for a second time span of 3 h. The leach mixture was left to cool down to 60 °C and was then filtered off through a filter chute. This way a filtrate and a dry filter cake could be obtained. A total organic carbon (TOC) content of 0.015 weight % was determined wherein each weight percent is by total weight of the filtrate.

### Phase Separation

After letting the filtrate stand overnight, 10 mL of kerosene were placed into a reaction vessel which was subsequently treated with 20 mL of the filtrate. The resulting two-phase system was shaken vigorously for 1 min. The resulting two-phase system was shaken vigorously for 1 min and a near complete phase separation occurred within 90 s.

### Example 5

### Leaching

In this example, 75 g black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 5 h. Additionally, during leaching under aerobic conditions an oxidant was added into the reaction mixture. The resulting leach mixture was stirred. After stirring for a first time span of 2 h the leach mixture was treated with 0.75 g of granular activated carbon with a 12×40 mesh to obtain a leach mixture enriched with activated carbon, whereafter the stirring was continued for a second time span of 3 h. The leach mixture was left to cool down to 60 °C and was then filtered off through a filter chute. This way a filtrate and a dry filter cake could be obtained. A total organic carbon (TOC) content 0.0036 weight % was determined wherein each weight percent is by total weight of the filtrate.

### Phase Separation

After letting the filtrate stand overnight, 10 mL of kerosene were placed into a reaction vessel which was subsequently treated with 20 mL of the filtrate. The resulting two-phase system was shaken vigorously for 1 min. The resulting two-phase system was shaken vigorously for 1 min, whereafter the phase separation occurred within 90 s.

### Example 6

### Leaching

In this example, 75 g black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 6 h. Additionally, during leaching under aerobic conditions an oxidant was added into the reaction mixture. The resulting leach mixture was stirred. After stirring for a first time span of 2 h the reaction mixture was treated with 0.75 g of granular activated carbon with a 12×40 mesh to obtain a leach mixture enriched with activated carbon, whereafter the stirring was continued for a second time span of 4 h. The leach mixture enriched with activated carbon was left to cool down to 60 °C and was then filtered off through a filter chute. This way a filtrate and a dry filter cake could be obtained. A total organic carbon (TOC) content of 0,028 weight % was determined wherein each weight percent is by total weight of the filtrate.

### Phase Separation

After letting the filtrate stand overnight, 10 mL of kerosene were placed into a reaction vessel which was subsequently treated with 20 mL of the filtrate. The resulting two-phase system was shaken vigorously for 1 min, whereafter the phase separation occurred within 60 s.

### Example 7

### Leaching

50 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 6 h and 30 min. Additionally, during leaching under aerobic conditions an oxidant was added into the reaction mixture. The resulting leach mixture was stirred. After stirring for a first time span of 6 h the leach mixture was treated with 0.5 g of granular activated carbon with a 12×40 mesh to obtain a leach mixture mixture enriched with activated carbon, whereafter the stirring was continued for a second time span of 30 min. The leach mixture mixture enriched with activated carbon was left to cool down to 60 °C and was then filtered off through a filter chute. This way a filtrate and a dry filter cake could be obtained.

### Phase Separation

After letting the filtrate stand overnight, 10 mL of kerosene were placed into a reaction vessel which was subsequently treated with 20 mL of the filtrate. The resulting two-phase system was shaken vigorously for 1 min, whereafter no phase separation could be observed.

### Example 8

### Leaching

50 g thermally treated black mass obtained from battery waste processing, was suspended in deionized water to obtain an intermediate suspension, and subsequently heated up to 95 °C. The intermediate suspension was then treated dropwise with an amount of H₂SO₄ until reaching a pH sufficient for leaching the value metals. The reaction mixture was stirred first under inert and then under aerobic conditions for a total time span of 5 h and 30 min. Additionally, during leaching under aerobic conditions an oxidant was added into the reaction mixture. The resulting leach mixture was stirred. After stirring for a first time span of 5 h the leach mixture was treated with 2.5 g of granular activated carbon with a 12×40 mesh to obtain a leach mixture mixture enriched with activated carbon, whereafter the stirring was continued for a second time span of 30 min. The leach mixture mixture enriched with activated carbon was left to cool down to 60 °C and was then filtered off through a filter chute. This way a filtrate and a dry filter cake could be obtained.

### Phase Separation

After letting the filtrate stand overnight, 10 mL of kerosene were placed into a reaction vessel which was subsequently treated with 20 ml of the filtrate. The resulting two-phase system was shaken vigorously for 1 min, whereafter the phase separation occurred within 2 min.

Comparing Examples 1, 4, 5, 6 and 8 with Example 2, it is recognized that the treating of the leach mixture with activated carbon may result in enhanced leaching performance such as, for example, improved phase separation associated with better separation of metal ions.

Comparing Examples 4, 5 and 6 with Example 2, it is recognized that better phase separations can be achieved in examples 4, 5 and 6 compared to example 2, whereby the TOC content is not necessarily reduced by the addition of activated carbon. In the method according to the invention, the TOC content is essentially not reduced or remains essentially unchanged when activated carbon is added.

Comparing Example 4 with Example 8, it is recognized that when treating the leach mixture with activated carbon, the quantity of activated carbon used correlates with the second time span used for stirring after adding the activated carbon. The higher the quantity of activated carbon, the lower the second time span must be in order to achieve a phase separation, i.e. to obtain a phase separation at all and/or obtain a phase separation within a tolerable waiting time. A tolerable waiting time until the phase separation occurs can be set to 2 minutes, for example. The Examples 4 and 8 show that such a tolerable waiting time can be maintained, both when using 0.5 weight % activated carbon and a second time span of 3 h and when using 5 weight % activated carbon and a second time span of 0.5 h, each weight percent (weight %) is by total weight of the material that is treated with the activated carbon.

Comparing Examples 5 and 6, it is recognized that for the same quantity of activated carbon above a minimum quantity, the waiting time can be reduced if a longer second time span is chosen. While in Example 5 with the quantity of activated carbon of 1 weight % and a second time span of 3 hours, the waiting time is 90 seconds, in Example 6 with the same quantity of activated carbon, but a second time span of 4 hours, the waiting time is only 60 seconds.

Comparing Example 5 with Example 6, it is recognized that if the same quantity of activated carbon is used, the phase separation is achieved more quickly when the second time span used for stirring after addition of the activated carbon is longer. It should be noted that it has been shown that the specific composition of the black mass (the material) has no influence on the observed dependence between second time span and waiting time, at least not on the tendency dependence observed.

Comparing Examples 3, 4 and 5, it is recognized that when treating the leach mixture with activated carbon, the quantity of activated carbon used must be greater than or equal to a minimum quantity in order to obtain a satisfactory phase separation within a given tolerable waiting time. If the tolerable waiting time is, for example, 2 minutes, as chosen in the present examples 3, 4 and 5, the minimum quantity of activated carbon must be in the range of 0.5 weight %, each weight percent (weight %) is by total weight of the material that is treated with the activated carbon.

Comparing Example 1 with Example 8, it is recognized that when treating the leach mixture with activated carbon, at least similar results are achieved with activated carbon powder and granular activated carbon.

Comparing Example 7 with Example 8, it is recognized again that when treating the leach mixture with activated carbon, a minimum quantity of activated carbon must be used for a given second time span used for stirring after addition of the activated carbon.

1. A method for providing a purified leach solution of a material, the material comprising one or more metals in a zero oxidation state and one or more selected from the group consisting of metal oxides, metal hydroxides, metal carbonates and combinations thereof, wherein the method comprises:
contacting the material at a temperature ranging from 20 °C to 110 °C for a total time span ranging from 20 minutes to 10 hours with an acidic aqueous solution having a pH less than 6 and comprising one or more acids, whereby in the course of contacting a leach mixture is formed,
after stirring the leach mixture for a first time span during the total time span, treating the leach mixture with activated carbon, whereafter the stirring is continued for a second time span during the total time span to obtain a leach mixture enriched with activated carbon, and
subjecting the leach mixture enriched with activated carbon to a separation process to obtain a residue and as a supernatant a purified leach solution in the form of an aqueous solution comprising metal ions.

2. The method according to claim 1, wherein contacting the material at a temperature ranging from 20 °C to 110 °C for the total time span ranging from 20 minutes to 10 hours with an acidic aqueous solution comprises:
suspending the material in deionized water to obtain an intermediary suspension, and
subsequently treating the intermediary suspension with an amount of one or more of the acids to obtain a reaction mixture.

3. The method according to claim 2, further comprising:
stirring the reaction mixture first under inert gas and then under aerobic conditions, and
adding to the reaction mixture one or more oxidants and/or adding to the reaction mixture one or more reducing agents.

4. The method according to claim 1, wherein the separation process to obtain a residue and as a supernatant a purified leach solution in the form of an aqueous solution comprising metal ions is selected from the group consisting of one or more of a filtration, a sedimentation, a centrifugation, and combinations thereof.

5. The method according to claim 1, wherein the activated carbon is selected from the group consisting of activated carbon powder and granular activated carbon.

6. The method according to claim 5, wherein a quantity of activated carbon with which the leach mixture is treated is chosen to range in a quantity range from 0.1 weight percent to 10 weight percent wherein each weight percent is by total weight of the material.

7. The method according to claim 6, wherein the quantity of activated carbon with which the leach mixture is treated is correlated, within the quantity range, with the second time span via a monotonically decreasing function.

8. The method according to claim 1, wherein the second time span ranges from 20 minutes to 6 hours, the first time span and the second time span add up to the total time span.

9. The method according to claim 1, wherein the material is a lithium ion battery material comprising one or more selected from the group consisting of black mass, cathode active material, cathodes, cathode active material precursors, and combinations thereof, and/or wherein the material comprises one or more selected from the group consisting of lithium, nickel, cobalt, manganese, and combinations thereof.

10. The method according to claim 1, wherein the one or more metals in a zero oxidation state is selected from the group consisting of lithium, nickel, cobalt, copper, aluminium, iron, manganese, rare earth metals, and combinations thereof, and/or wherein the metal carbonates are selected from the group consisting of lithium carbonates, and/or wherein the metal oxides are selected from the group consisting of nickel oxides, cobalt oxides, copper oxides, aluminium oxide, iron oxides, manganese oxides, rare earth oxides, and combinations thereof, and/or wherein the metal hydroxides are selected from the group consisting of nickel hydroxides, cobalt hydroxides, copper hydroxides, aluminium hydroxide, iron hydroxides, manganese hydroxides, lithium hydroxides, rare earth hydroxides, alkaline earth hydroxides, and combinations thereof.

11. The method according to claim 1, wherein emulsifying agents and/or dispersion reagents present in the formed leach mixture are adsorbed, at least in part, by the added activated carbon, and are separated from the leach mixture together with the activated carbon in the separation process, leaving the purified leach solution.

12. The method according to claim 11 wherein the emulsifying agents and/or dispersion reagents present in the leach mixture are from the group comprising Si, C, O, nanoparticles with a particle size <500 nm, gel-like SiOx networks, polysiloxane and derivates, organic residues from a previous pyrolysis of organic binders, and combinations thereof.

13. A method comprising:
processing a battery material according to claim 1 to obtain an aqueous solution comprising metal ions, and separating the metal ions to obtain at least one essentially pure metal ion solution and/or at least one essentially pure solid metal ion salt.

14. The method according to claim 13, wherein separating the metal ions comprises one or more selected from the group consisting of a solid/liquid separation, an extraction, a precipitation, a crystallization, and combinations thereof.

15. A method comprising:
mechanically comminuting at least one battery material selected from the group consisting of a lithium ion battery, lithium ion battery waste, lithium ion battery production scrap, lithium ion cell production scrap, lithium ion cathode active material, and combinations thereof to obtain a black mass as the material, and
subjecting the black mass to the method according to claim 1, optionally further comprising subjecting the black mass to a heat treatment step prior to subjecting the black mass to the method.
